(19) United States
(12) Patent Application Publication
(10) Pub. No.: US 2009/0299731 A1
(43) Pub. Date: Dec. 3, 2009

(54) AURAL SIMILARITY MEASURING SYSTEM FOR TEXT

(75) Inventor: Mark Owen, Cambridge (GB)

Correspondence Address: VOLPE AND KOENIG, P.C., UNITED PLAZA, SUITE 1600, 30 SOUTH 17TH STREET, PHILADELPHIA, PA, 19103, US

(73) Assignee: MONGOOSE VENTURES LIMITED, Windsor (GB)

(21) Appl. No.: 12/537,498

(22) Filed: Aug. 7, 2009

Related U.S. Application Data
(63) Continuation-in-part of application No. 12/042,690, filed on Mar. 5, 2008.

(30) Foreign Application Priority Data
Mar. 12, 2007 (GB) 0704772.3

(51) Int. Cl. G06F 17/27

(52) U.S. Cl. 704/9

(57) ABSTRACT

The aural similarity measuring system and method provides a measure of the aural similarity between a target text (10) and one or more reference texts (11). Both the target text (10) and the reference texts (11) are converted into a string of phonemes (15) and then one or other of the phoneme strings are adjusted (16) so that both are equal in length. The phoneme strings are compared (12) and a score generated representative of the degree of similarity of the two phoneme strings. Finally, where there is a plurality of reference texts the similarity scores for each of the reference texts are ranked (13). With this aural similarity measuring system the analysis is automated thereby reducing risks of errors and omissions. Moreover, the system provides an objective measure of aural similarity enabling consistency of comparison in results and reproducibility of results.

This application is a continuation in part of and claims priority from U.S. patent application Ser. No. 12/042,690 which in turn claims priority from United Kingdom Patent Application Serial No. 0704772.3, filed 12 Mar. 2007, inventor Mark Owen, entitled “Aural Similarity Measuring System For Text”, the contents of which are incorporated herein by reference, and with priority claimed for all commonly disclosed subject matter.

### FIELD OF THE INVENTION

The present invention relates to an aural similarity measuring system and method for text and to a software product for measuring aural similarity of texts. The present invention is particularly suited for, but is not limited to, use in the assessment of trademark similarity.

The general function of trademarks is to distinguish a person's or an organisation's products or services from those of other people and other companies or organisations in order to engender customer loyalty. It is important therefore that a trademark is capable of being recognised by customers and of not being confused with other trademarks. When a person, company or other organisation is deciding upon a new trademark, it is usual for searches to be conducted to check whether their preferred new trademark is not identical to or confusingly similar to an existing trademark. Such searches usually involve checks with individuals familiar with the relevant industry, through relevant trade journals to identify trademarks in use in that industry, as well as checks through national trademark registers. In addition, where an application is filed to officially register a new trademark with a registration authority, many registration authorities conduct searches through their own registers to identify earlier registrations or pending applications of trademarks identical or similar to the new trademark. When considering the potential for confusion between two trademarks, not only must visual similarity be considered but also conceptual and aural similarity.

### DESCRIPTION OF THE RELATED ART

In the past, searches through the official trademark registers have been carried out manually. In view of the vast number of registered trademarks such manual searches are therefore time consuming and are also potentially unreliable. A person manually searching through such a plethora of registered trademarks is liable to overlook a potentially similar trademark. Such a failure can prove extremely costly where a person or organisation in the process of adopting a new trademark is forced to abandon their new trademark and to destroy all packaging or other material bearing that new trademark because of a, previously unidentified, conflict with a similar prior-existing trademark.

Because of the problems inherent in manual searching, attempts have been made to computerise the searching of trademark data on official trademark registers. Whilst such searching software is effective in the identification of identical trademarks, the identification of similar marks remains semi-manual. To identify similar trademarks a user of the searching software is required to identify permutations of the trademark being searched so that identical searches can be performed in respect of these permutations and to identify key, distinctive elements of a trademark, e.g. its suffix or prefix, for which identical searches are then performed for those elements, irrespective of any other elements that might be present.

The semi-manual nature of searches for confusingly similar trademarks means that such searches remain prone to error. Also, the decision on whether or not two trademarks are similar remains the decision of the user and, as such, is subjective.

So-called fuzzy matching program techniques are known for determining the similarity of two objects automatically, for example in DNA sequence matching, in spell checker ‘suggested correction’ generation and in directory enquiries database searches. Such techniques have not, though, been employed in automated trademark searching.

Conventional fuzzy matching techniques fall broadly into two categories, which might be called ‘edit distance methods’ and ‘mapping methods’. In the case of edit distance methods, the similarity of two words A and B are measured by answering a question along the lines of “what is the minimum number of key strokes it would take to edit word A into word B using a word processor?” The Levenshtein distance is the most popular of these measures. Edit distance methods are essentially a measure of visual similarity and are not directly suitable for measuring aural similarity. They also lack flexibility and are not very discriminating.

Mapping methods work by assigning a key value to each possible word. However, there are many times fewer different keys than different words, and so several words are mapped onto each key. The mapping is designed so that similar-sounding words receive identical keys, and so a direct look-up from the key is possible. Popular mapping methods include Soundex™, Metaphone™ and Double Metaphone™. It is possible to imagine the space of words divided into regions, where each region contains all the words mapped to a given key: mapping methods work poorly with words near to the edge of a region of this space as their similarity to nearby words that happen to be in an adjacent region is not recognised. They have the further disadvantage of simply providing a yes-no answer to the similarity question rather than assigning a value representative of similarity. Mapping methods are also unsuitable for matching substrings.

### SUMMARY OF THE INVENTION

The present invention seeks to overcome the disadvantages in the trademark searching procedures described above and thus seeks to provide a trademark searching system and a trademark searching software product which automates assessment of aural and/or visual similarity between trademarks.

Moreover, with the present invention substrings (where the sound of one mark is contained entirely within that of another) can be more readily matched, which is an important aspect of trademark similarity assessment.

Also, the present invention seeks to identify permutations of a trademark to be searched.

Furthermore, the present invention seeks to provide a trademark searching system and method which provides comparison between its own results and those generated through alternative search strategies and methodologies.

The present invention therefore provides an aural similarity measuring system for measuring the aural similarity of texts comprising: a text input interface; a reference text source; an output interface; and a processor adapted to convert the input text into a string of phonemes, to adjust the phoneme string of the input text and/or a phoneme string of a reference text so that the two phoneme strings are equal in length, and to assign a score to the reference text representative of the similarity of the two phoneme strings, which score is output via the output interface.

Preferably the system includes a data store in which is stored a plurality of reference texts. More preferably, the data store may further contain a plurality of phoneme strings each string being associated with a reference text.

In a preferred embodiment the processor is further adapted to select one or more reference texts from the plurality of reference texts for outputting via the output interface, the selection being based on the score assigned to each reference text.

Also, ideally the processor is adapted to determine all possible adjustments of one or both of the input text phoneme string and the reference text phoneme string and is adapted to identify the score representing the highest measure of similarity with respect to all of the possible phoneme string adjustments.

In the preferred embodiment, the processor is adapted to adjust the phoneme strings of either or both of the input text and/or the reference text by inserting gaps into the phoneme strings. Furthermore, the processor may be adapted to identify aligned phonemes which differ; to allocate predetermined phoneme scores for each pair of differing aligned phonemes; and to summing the individual phoneme scores to thereby assign a score to the reference text.

With the preferred embodiment, the processor may be adapted to weight the phoneme scores in dependence upon the position of the pair of phonemes in the phoneme strings. Also, the processor may be adapted to weight the phoneme scores such that phoneme scores arising from partial text predetermined as less relevant which is present in the input text are lower than equivalent phoneme scores arising from other partial text in the input text and the processor may be adapted to allocate a higher phoneme score to a grouping of non-adjusted aligned phonemes than to an equivalent grouping of aligned phonemes which have been adjusted.

In a preferred embodiment the processor may be adapted to weight the phoneme scores on the basis of user indicated descriptiveness of a word of which a phoneme forms at least a part or on the basis of automated identification of descriptiveness of a word of which the phoneme forms at least a part.

In this way those phonemes which form at least a part of words of the input text that a user has indicated are wholly descriptive are assigned a lower weight than equivalent phoneme scores for phonemes which form at least a part of words of the input text that the user has indicated are non-descriptive. Similarly, those phonemes arising from words of the input text and/or the reference text that the processor determines to be wholly descriptive are assigned a lower weight than equivalent phoneme scores arising from words of the input text that the processor has determined are non-descriptive.

The processor may be adapted to determine which words of the input text and/or the reference text are descriptive by reference to the frequency with which a word occurs in ordinary language.

In a second aspect the present invention provides a trademark searching system comprising an aural similarity measuring system as described above, wherein the reference text source comprises a trademark data source and the processor is adapted to generate a similarity score with respect to the aural similarity between an input trademark and at least one reference trademark from the trademark data source.

The processor may be adapted to determine which words of the input trademark and/or which words of the trademark data source are descriptive, by reference to the frequency with which words occur in ordinary language. Separately or in combination with the above, the processor may be adapted to determine which words of the input trademark and/or which words of the trademark data source are descriptive, by reference to the frequency with which words occur in registered trademarks in general and/or by reference to the frequency with which words occur in registered trademarks associated with goods or services identical or similar to those with which the input text is associated. Insofar as automatically determining which words are descriptive is concerned, the processor may be adapted to determine which words of the input trademark and/or which words of the trademark data source are descriptive by reference to the number of unrelated proprietors owning registered trademarks containing the word.

In a third aspect the present invention provides an aural similarity measuring server comprising: an input/output interface adapted for communication with one or more remote user terminals and further adapted to receive an input text and to output one or more reference texts each associated with a similarity score; a data store in which is stored a plurality of reference texts; and a processor adapted to convert an input text into a string of phonemes, to adjust the phoneme string of the input text and/or a phoneme string of a reference text so that the two phoneme strings are equal in length, and to assign a score to the reference text representative of the similarity of the two phoneme strings, which score is output via the input/output interface.

In a fourth aspect the present invention provides a trademark searching server comprising an aural similarity server as described above, wherein a plurality of reference trademarks are stored in the data store and the processor is adapted to generate a similarity score with respect to the aural similarity between an input trademark and at least one reference trademark from the data store.

In a fifth aspect the present invention provides an aural similarity measuring software program product comprising program instructions for performing the following steps: a receiving step in which an input text for which an aural similarity score is required is received; a conversion step in which the input text is converted into a string of phonemes; an adjustment step in which the phoneme string for the input text and/or a phoneme string associated with a reference text is adjusted so that the two phoneme strings are equal in length; a ranking step in which the similarity of the two phoneme strings is assigned a score; and an output step in which the reference text and the its ranking is output to the user.

Ideally, the adjustment step and the ranking step are repeated for a plurality of reference texts.

In a preferred embodiment the program product further comprises program instructions for a selection step in advance of the output step in which one or more reference texts are selected from the plurality of reference texts for outputting, the selection being based on the ranking assigned to each reference text.

The adjustment step may comprise determining all possible adjustments of one or both of the input text phoneme string and the reference text phoneme string and the ranking step identifies the lowest similarity score, which represents the best similarity, with respect to all of the possible phoneme string adjustments.

Preferably, the adjustment step comprises adding one or more gaps in the phoneme string and the one or more gaps made may be added to the beginning or end of a phoneme string.

With the preferred embodiment the ranking step comprises identifying aligned phonemes which differ; allocating predetermined phoneme scores for each pair of differing aligned phonemes and summing the individual phoneme scores. Also, the phoneme scores may be weighted in dependence upon the position of the pair of phonemes in the phoneme strings and/or the phoneme scores may be weighted such that phoneme scores arising from partial text predetermined as less relevant in the input text are lower than equivalent phoneme scores arising from other partial text in the input text. Furthermore, a higher phoneme score may be allocated to a grouping of non-adjusted aligned phonemes than to an equivalent grouping of aligned phonemes which have been adjusted.

The phoneme scores may be weighted on the basis of user indicated descriptiveness of a word of which a phoneme forms at least a part or on the basis of automated identification of descriptiveness of a word of which the phoneme forms at least a part.

Which words of the input text and/or which words of the reference text are descriptive may be determined by reference to the frequency with which words occur in ordinary language. Similarly, in the case where the input text is a trademark, which words of the input trademark and/or which words of the trademark data source are descriptive may be determined by reference to the frequency with which words occur in ordinary language. Alternatively, or in combination with the former, the descriptiveness of words of the input trademark and/or the descriptiveness of words of the trademark data source may be determined by reference to the frequency with which words occur in registered trademarks in general and/or by reference to the frequency with which words occur in registered trademarks associated with goods or services identical or similar to those goods or services with which the input trademark is associated. Insofar as automatically determining which words are descriptive is concerned, which words of the input trademark and/or which words of the trademark data source are descriptive may be determined by reference to the number of distinct or unrelated proprietors owning registered trademarks that contain the word.

In a sixth aspect the present invention provides an aural similarity measuring method for measuring the aural similarity of texts, the method comprising the steps of: receiving an input text for which an aural similarity score is required; converting the input text into a string of phonemes; adjusting the phoneme string for the input text and/or a phoneme string associated with a reference text so that the two phoneme strings are equal in length; ranking the similarity of the two phoneme strings to assign a score; and outputting the reference text and the its ranking to the user.

In a seventh aspect the present invention provides a trademark searching method for measuring the aural similarity of trademarks, the method comprising the steps of: receiving an input trademark for which an aural similarity score is required; converting the input trademark into a string of phonemes; adjusting the phoneme string for the input trademark and/or a phoneme string associated with a reference trademark so that the two phoneme strings are equal in length; ranking the similarity of the two phoneme strings to assign a score; repeating the adjusting and ranking steps for further reference trademarks; and outputting the reference trademarks and their associated rankings to the user.

Thus, with the present invention the aural similarity measurement of texts and the searching of aurally similar trademarks is wholly automated which significantly reduces the risk of errors and omissions and also provides an objective assessment of similarity. The present invention is also adapted to say whether one trademark is more similar than another and thus enables similar trademarks to be ranked. This has the further benefit of helping the user weigh the relative merits of, for example, a distant match with a trademark associated with the same goods or services and a close match with a trademark associated with different goods or services.

The present invention is also suitable for use in the training of individuals in the performance of trademark searching. In this case an individual may perform semi-manual trademark searching in which they program the searching strategy and select similar trademarks found through the performance of their searching criteria. The results are then compared against those generated using the system and method of the present invention for the purposes of identifying errors or omissions in the semi-manual trademark searching strategy. In a similar way, the system and method of the present invention may be used to provide a ‘second opinion’ of the search results produced using semi-manual searching strategies.

### BRIEF DESCRIPTION OF THE DRAWINGS

Exemplary embodiments of the present invention will now be described by way of example with reference to the accompanying drawings, in which:

FIG. 1 is a schematic diagram of a trademark searching system in accordance with the present invention;

FIG. 2 schematically illustrates the functionality of the trademark searching system in accordance with the present invention;

FIG. 3 schematically illustrates the text-to-phoneme conversion performed as part of the similar trademark searching method in accordance with the present invention;

FIG. 4 schematically illustrates the word-to-phoneme conversion performed as part of the similar trademark searching method in accordance with the present invention;

FIG. 5 illustrates a first alignment of phonemes in accordance with the present invention for the words “stripe” and “trumps”; and

FIG. 6 illustrates a second, alternative alignment of phonemes for the words “stripe” and “trumps”, also in accordance with the present invention.

### DETAILED DESCRIPTION OF EXEMPLARY EMBODIMENTS

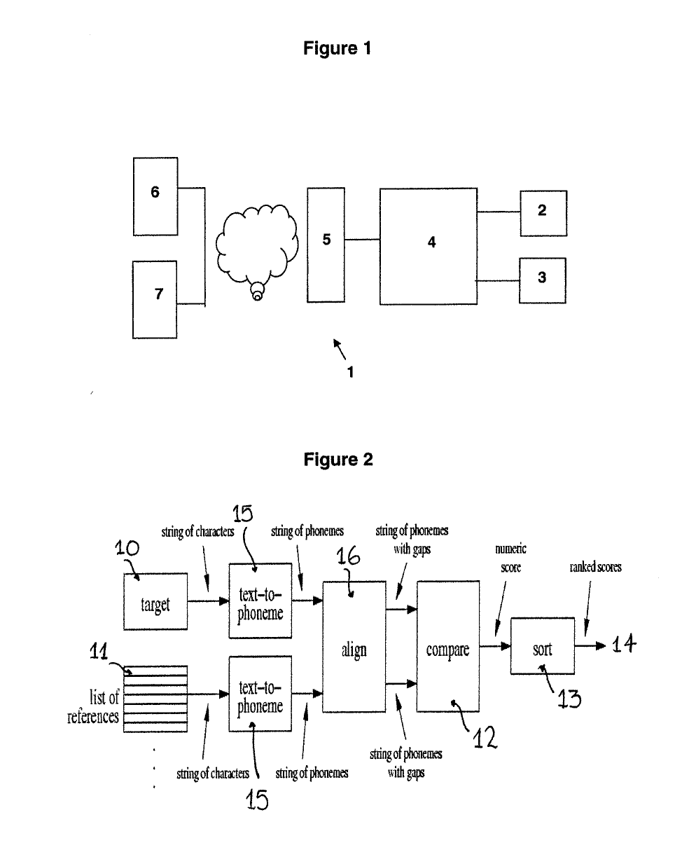

The trademark searching system 1 illustrated in FIG. 1 comprises the following basic elements: a data store 2, in the form of a memory, in which is stored trademark data; a program store 3, also in the form of a memory, in which is stored a software program product; a processor 4, in communication with the data store 2 and the program store 3, for performing trademark searching functions; an input/output (I/O) interface 5 in communication with the processor 4 for providing user access to and from the processor 4; a user input interface 6 including, for example, a keyboard and/or a tracking device (mouse) and an output interface 7 such as, but not limited to, a display screen and/or printer terminal. The trademark searching system 1 may be implemented as a stand-alone system using a conventional desktop computer. Alternatively, as illustrated in FIG. 1, the trademark searching system may be implemented using a remote server which is in communication by means of the I/O interface 5 with one or more user terminals via a private or public communications network such as, but not limited to, the internet.

An overall block diagram of the trademark search system for performing aural similarity searching is shown in FIG. 2. At the top left a trademark for which a search is required, called the ‘target’, is input 10 by the user into the searching system using the user input interface 6. At the bottom left of FIG. 2 a list of existing trademarks, called ‘references’, which are to be searched through by the searching system, are accessed 11 for example from the data store 2. In each case the target and references are input as strings of characters. The target is compared 12 in turn with each reference and the similarity between the target trademark and each reference trademark is ranked. The references are then sorted into a list 13 in terms of their similarity ranking with the sorted list being output 14 either as a complete list or as a selection taken from the complete list. Where only a selection of reference trademarks are output, the selection may be made on the basis of those trademarks having a similarity ranking below a predetermined threshold ranking. Alternatively, the selection may be made on the basis of the lowest scoring reference trademarks up to a predetermined number e.g. 50 or 100. The list is output 14 to the user by means of the output interface 7 and displayed, for example, on a display screen and/or printed off.

In order to perform the comparison of the target with a reference trademark the following sequence of steps is performed. Both the target and each reference are converted 15 from a plain textual form into a phonetic form by means of a conversion unit. Although two conversion units are illustrated in FIG. 2, it will, of course, be apparent that the same text-to-phoneme conversion is applied to both the target and the references. Both the target and the reference are now represented as strings of phonemes which correspond to the basic units of speech. For example, the word ‘caught’ would be converted into the three phonemes /k/, /aw/, and /t/. For clarity here we represent phonemes by letters intended to be evocative of their sound, bracketed by ‘/’ characters; in a practical system they can be represented by numeric codes. After the trademarks have been converted, the phonetic version of each reference is aligned 16 with the phonetic version of the target in turn and once aligned both the target and the reference are communicated from the alignment unit 16 to the comparator 12 for the purposes of determining a similarity ranking for the reference trademark.

Thus, the similarity search generally comprises an inputting step in which the trademark to be searched (the target) is input into the system; a conversion step in which the target trademark is converted into a string of phonemes; an alignment step in which the phoneme string for the target trademark is aligned with a plurality of phoneme strings associated with a respective plurality of reference trademarks; a ranking step in which the similarity of the aligned phoneme strings are assigned a score; and an output step in which the reference trademarks and their assigned similarity scores are output to the user.

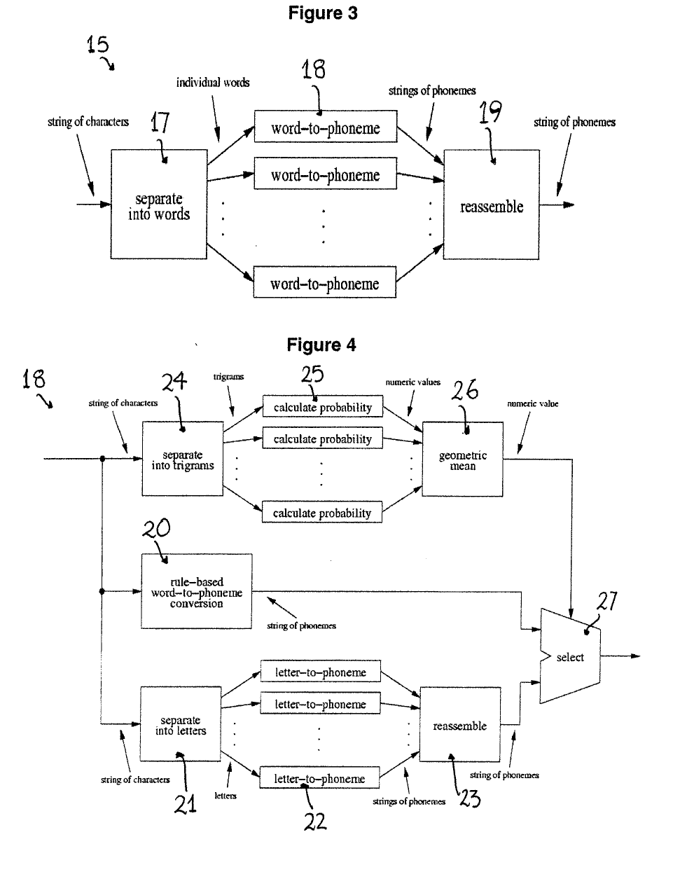

The text-to-phoneme conversion 15 is illustrated in more detail in FIG. 3. The string of characters constituting a trademark is first divided into its constituent words 17 and then each word is separately converted from text to phonemes 18. The results of these text-to-phoneme conversions are then reassembled 19 into a string of phonemes.

The word-to-phoneme conversion 18 is illustrated in FIG. 4. Across the top of the Figure is a process used to decide whether the word is, on the one hand, an ordinary word or an abbreviation which would naturally be pronounced (such as ‘PAL’), or, on the other hand, an abbreviation that would naturally be spelt out (such as ‘NTSC’). The processing of each of these two cases is then illustrated in the middle and bottom rows of FIG. 4, respectively. In the former case, i.e. a pronounceable word, a standard rule-based process 20 is applied to convert the word into a string of phonemes. In the latter case, i.e. a spelt out abbreviation, the word is split into its constituent letters 21 which are individually converted into phoneme strings 22, so that “s”, for example, becomes /eh/ /s/ and ‘w’ becomes /d/ /uh/ /b/ /l/ /y/ /oo/. The phoneme strings are then reassembled 23 into a single string representing the pronunciation of the abbreviation.

The choice between the two alternative phonetic representations of a word is made as follows. If the word consists of a single letter or contains digits it is spelt out. (This case is omitted from FIG. 4 for the sake of clarity). Otherwise the word, including the space on either side of it, is divided 24 into overlapping sets of three letters called ‘trigrams’. Thus ‘_PAL_’ (with ‘_’ standing for the space) is split into ‘_PA’, ‘PAL’ and ‘AL_’, while ‘NTSC’ is split into ‘_NT’, ‘NTS’, ‘TSC’ and ‘SC_’. Each of these trigrams is passed through a probability calculation unit 25 where each trigram is converted into a numeric value. The numeric value assigned to each trigram reflects the probability of that trigram forming a part of a pronounceable word and is derived from an analysis of the relative frequencies of trigrams contained in a sample of dictionary words. The geometric mean of the numeric values corresponding to all of the trigrams forming the trademark is then calculated 26. The resultant mean probability is a quantity which can be compared against a predetermined fixed probability threshold (determined empirically) to decide or select 27 which of the two phonetic conversions described above should be used.

An alternative, but less desirable, method for determining whether a word to be converted is a pronounceable word or a series of individually pronounced letters, bases the decision on whether the word to be converted is present in a dictionary. This method is less desirable because a very large number of trademarks include, for example, proper names which might not be covered by a dictionary and also made-up, but nevertheless pronounceable, words.

Returning to FIG. 2, as mentioned earlier, the string of phonemes describing the target trademark and the string of phonemes describing a reference trademark are passed through an aligner 16 whose job is to try to match up the two strings of phonemes. In order to match up the two strings of phonemes the aligner 16 inserts gaps into the two strings so that (a) they are made the same length; and (b) as many as possible of the phonemes in corresponding positions are as similar as possible. Thus, the two phoneme strings are warped to aid comparison. As an aid to understanding, consider the following example:

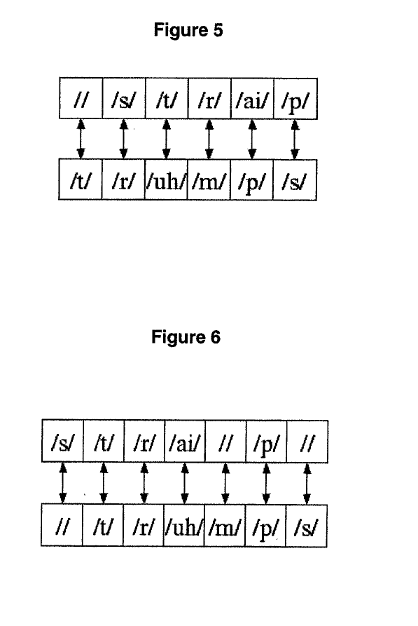

The two trademarks being examined are ‘stripe’ and ‘trumps’. As strings of phonemes these might be represented respectively as ‘/s/ /t/ /r/ /ai/ /p/’ (five phonemes in total) and ‘/t/ /r/ /uh/ /m/ /p/ /s/’ (six phonemes in total). To make these the same length by inserting gaps into them the aligner 16 needs to insert one more gap into the first string than into the second. For example, it could insert a gap at the start of the first string and leave the second string alone: this alignment is illustrated in FIG. 5. An alternative alignment, inserting two gaps into the first string and one gap into the second string, is illustrated in FIG. 6.

Ideally, all possible alignment permutations between the target string of phonemes and the reference string of phonemes are considered. This generates a plurality of sets of aligned pairs of phoneme strings with the alignment within each set being different. Each set of phoneme strings is then assigned a score and the lowest score (representing the highest possible similarity) of all of the sets of phoneme strings is then allocated to the reference trademark as a similarity ranking.

As mentioned above, each set of aligned strings is input into the comparator 12 (see FIG. 2) where each set is assigned a score or similarity ranking calculated on the basis of the difference between them. A high score (i.e., a large difference) thus corresponds to a poor match (little similarity), and a low score to a good match (high similarity). The score value consists of two elements: (a) a phoneme-by-phoneme difference element calculated between corresponding pairs of phonemes; and (b) a value element reflecting the quantity and positions of gaps that were inserted by the aligner 16. The range of scores may, of course, vary but is chosen to be sufficient to enable adequate discrimination between different reference trademarks which are similar with a target trademark in different ways.

The phoneme-by-phoneme difference element is calculated as the sum of difference values between phonemes in corresponding positions in the two aligned strings. Two phonemes have a difference value of zero if they are identical; otherwise the difference value is a small offset plus a combination of individual phonetic feature difference values. These phonetic feature differences include whether the phoneme is a consonantal or vowel sound, whether the sound is voiced or not, and the position in the mouth where the sound is made. Where a phoneme in one string is aligned with a gap in the other, the contribution to the score is based on the features of that phoneme in a similar way. The example in FIG. 5 would give a large difference score because in each of the six phoneme-to-phoneme comparisons the phonemes involved are quite different from one another. In the alignment shown in FIG. 6, however, many of the seven comparisons are between similar or identical phonemes, and so the total difference score would be lower.

As mentioned above, the gap positions chosen by the aligner 16 can contribute to the score. The exact contribution depends on the relative and absolute positions of the gaps. Gaps inserted at the beginning or end of either string are given a smaller difference value than normal: the effect of this is to reduce the total difference score when one string is a substring or similar to a substring of the other. Gaps inserted between consecutive pairs of phonemes incur a greater difference score than normal: the effect of this is to reduce the total difference score when there are consecutive runs of matching or similar phonemes in the two strings. The gap positions shown in FIG. 5 would only result in a small amount being added to the total difference value, whereas the gap positions shown in FIG. 6 would result in a larger addition, chiefly because of the gap inserted between the /ai/ and /p/ phonemes in the rendering of ‘stripe’. In practice the various contributions to the score are weighted so that the alignment shown in FIG. 6 would be preferred over that shown in FIG. 5.

As an aid in understanding the scoring of phoneme alignment, Tables 1 and 2 below set out an example of the scoring respectively for each of the two alignments illustrated in FIGS. 5 and 6.

TABLE 1

| STRIPE | TRUMPS | Initial | Adjusted |
|---|---|---|---|
| Phoneme | Phoneme | Phoneme Score | Phoneme Score |
| / / | /t/ | 0.56 | 0.56 |
| /s/ | /r/ | 0.55 | 1.35625* |
| /t/ | /uh/ | 1.0 | |
| /r/ | /m/ | 0.5 | 1.3125* |
| /ai/ | /p/ | 1.0 | |
| /p/ | /s/ | 0.5 | 0.5 |

*the combined phoneme scores have been adjusted down in each case to take into account the positions of the gaps.

The similarity ranking for the phoneme alignment of FIG. 5 is the total of the scores in the Adjusted Phoneme Score column, which is 3.72875

TABLE 2

| STRIPE | TRUMPS | Initial | Adjusted |
|---|---|---|---|
| Phoneme | Phoneme | Phoneme Score | Phoneme Score |
| /s/ | / / | 0.56 | 0.28** |
| /t/ | /t/ | 0.0 | 0.0 |
| /r/ | /r/ | 0.0 | 0.328125* |
| /ai/ | /uh/ | 0.375 | |
| / / | /m/ | 0.7 | 0.7 |
| /p/ | /p/ | 0.0 | 0.0 |
| / / | /s/ | 0.56 | 0.56 |

**the phoneme score has been adjusted down because the insertion of a gap at the beginning or the end of a word has less of a difference effect.

Thus, the similarity ranking for the phoneme alignment illustrated in FIG. 6 is, therefore, 1.868125.

In practice a large number of different alignments between the same set of two phoneme strings is analysed and only the one with the best (i.e., lowest) similarity ranking is retained.

In some cases the efficiency of the alignment and scoring process can be improved using a conventional algorithm known as ‘dynamic programming’. This algorithm, optionally, may be used to examine all possible alignments of the target and reference strings in an efficient manner.

The scoring rules described above can be modified so that scores derived from parts of the alignment nearer to the beginning of the strings are amplified and scores derived from later parts of the alignment attenuated. The effect of this is to bias the similarity ranking to favour (other things being equal) those matches whose initial parts are similar over those whose final parts are similar. This is in accordance with how the similarity of trademarks is judged manually and leads to more accurate results.

The scoring rules described above can be modified to enable the user of the searching system to identify parts of a target trademark which are more significant than others. This indication is preserved by the text-to-phoneme units 15 so that some of the phonemes in the target phoneme string are marked as significant. The scores derived from parts of the alignment involving these more significant phonemes are amplified. The effect of this is to bias the scoring to favour (other things being equal) those strings where there is an aural match in the parts indicated as more significant. The system can therefore emulate more accurately the manual process of judging the similarity of trademarks, where generic parts of a trademark e.g. “company” or wholly descriptive words are normally given less weight.

Which parts of a trademark are generic or descriptive and which are not may be indicated manually to the system by the user. Alternatively, it is possible for the system to make an automatic determination. Preferably, automatic determination of descriptiveness is applied by the searching system to both the input trademark and the reference trademark.

In the case of automatic determination of descriptiveness, the descriptiveness of a given word is calculated as a simple combination of its frequency of occurrence in ordinary language and the number of distinct or unrelated proprietors holding already-registered trademarks incorporating the given word for identical and/or similar goods or services e.g. in the same or related classifications of goods or services, biased towards the latter. This ensures that the system can determine, for example, that “ALE” is a descriptive word in trademarks relating to alcoholic beverages in addition to the determination that certain other everyday words offer little distinctiveness in a trademark irrespective of the goods or services involved. The approach of counting distinct or unrelated proprietors ensures that the searching system is not unduly biased by the existence of a single trademark proprietor holding a large number of registrations including a distinctive brand name or ‘house’ name.

The scored results are then sorted into increasing order of score, in the unit marked ‘sort’ in FIG. 1. The result is a list of the reference marks in descending order of perceived aural similarity to the target mark. The sorted results can then be displayed to the user, much like those produced by an Internet search engine.

Although the ranking is described in relation to a low score representing high similarity, it is possible for the reciprocal of the score to be determined in which case a low score will represent a low degree of similarity.

Registered trademarks are assigned to one or more classes which are representative of the specific businesses in relation to which the registered trademark is intended to be used. Where the trademark class (or classes) of the target trademark is known, it is possible to divide the search results into three groups: those reference marks registered in the same trademark class as the (or a) class of the target trademark; reference marks registered in classes related to the (or a) class of the target trademark, i.e., those classes in which a cross-search (pre-defined associations between classes) would be triggered; and reference marks in other classes.

It can be seen that the searching system described above can readily be adapted to analyse the visual similarity of two marks by omitting the text-to-phoneme conversion units and treating letters of the alphabet as if they were phonemes in the subsequent components of the system.

As already noted, in many instances the identification of similar marks remains semi-manual. To identify similar trademarks a user of the searching software may wish to devise their own searching strategy in which they identify permutations of a trademark to be searched and to then perform identical searches in respect of each permutation. Also the user may choose to identify key, distinctive elements of a trademark, e.g. its suffix or prefix, for which an identical search is then performed for those elements, irrespective of any other elements that might be present. This semi-manual search for confusingly similar trademarks means that such searches remain prone to error, and not all potentially similar trademarks may be identified.

For a variety of reasons some users will wish to continue to perform semi-manual searches. However, the trademark searching system described herein may be combined with a series of semi-manual identical searches and thus may be used to identify similar trademarks which fail to be identified in the semi-manual searches: in effect the trademark similarity system and method described herein can be employed as a back-up or training service to more conventional semi-manual searching. In this regard, the results of the trademark similarity search may be combined with the results from one or more semi-manual identical searches to identify omissions from either set of results.

The results obtained for each semi-manual identical search and for the automated similarity search may be stored in individual data stores. This enables the results to be combined automatically or reserved for combining at the user's request. In the latter case the contents of the individual data stores may be compared and where the similarity search results identify trademarks not to be found in the search results of the semi-manual searches, the user may be informed that additional results are available for combining with the original semi-manual search results, if desired.

Although in FIG. 2 the reference trademarks are shown being input into the conversion unit 15, it will be immediately apparent that in an alternative, the phoneme strings for each reference trademark may be identified in advance and stored in association with the reference trademark in the data store 2.

The specific example given above of a trademark searching system contains details which are not essential to the present invention and which may be altered and adjusted where necessary. In particular, to aid understanding the searching method has been described in relation to functional units. In practice, such functional units are preferably implemented in a software program product or alternatively in an ASIC. The scope of the present invention is defined solely in the accompanying claims.

What we claim is:

1. An aural similarity measuring system for measuring the aural similarity of texts comprising:
a text input interface;
a reference text source;
an output interface; and
a processor adapted to convert the input text into a string of phonemes, to adjust the phoneme string of the input text and/or a phoneme string of a reference text so that the two phoneme strings are equal in length, and to assign a score to the reference text representative of the similarity of the two phoneme strings, which score is output via the output interface.

2. An aural similarity measuring system as claimed in claim 1, further comprising a data store in which is stored a plurality of reference texts.

3. An aural similarity measuring system as claimed in claim 1, wherein the processor is adapted to determine one or more adjustments of one or both of the input text phoneme string and the reference text phoneme string and is adapted to identify the score representing the highest measure of similarity with respect to the possible adjusted phoneme strings.

4. An aural similarity measuring system as claimed in claim 1, wherein the processor is adapted to identify matches between words in the input text and one or more pre-determined descriptive words; and is adapted to apply a weighting to a phoneme score where the phoneme score applies to a phoneme forming at least part of a pre-determined descriptive word.

5. An aural similarity measuring system as claimed in claim 2, wherein the processor is further adapted to select one or more reference texts from the plurality of reference texts for outputting via the output interface, the selection being based on the score assigned to each reference text, and the processor is further adapted to compare the selected one or more reference texts with reference texts selected by means of a different methodology for the purposes of identifying differences.

6. A trademark searching system comprising an aural similarity measuring system in accordance with claim 1, wherein the reference text source comprises a trademark data source and the processor is adapted to generate a similarity score with respect to the aural similarity between an input trademark and at least one reference trademark from the trademark data source.

7. A trademark searching system as claimed in claim 6, wherein the processor is adapted to identify descriptive words with respect to one or more of the following: i) the frequency with which the word occurs in ordinary language; ii) the frequency with which the word occurs in registered trademarks in one or more or all classes of goods or services; and iii) the number of distinct proprietors owning registered trademarks which include the word.

8. An aural similarity measuring server comprising:
an input/output interface adapted for communication with one or more remote user terminals and further adapted to receive an input text and to output one or more reference texts each associated with a similarity score;
a data store in which is stored a plurality of reference texts; and
a processor adapted to convert an input text into a string of phonemes, to adjust the phoneme string of the input text and/or a phoneme string of a reference text so that the two phoneme strings are equal in length, and to assign a score to the reference text representative of the similarity of the two phoneme strings, which score is output via the input/output interface.

9. An aural similarity measuring server as claimed in claim 8, wherein the processor is adapted to determine one or more adjustments of one or both of the input text phoneme string and the reference text phoneme string and is adapted to identify the score representing the highest measure of similarity with respect to the possible adjusted phoneme strings.

10. An aural similarity measuring server as claimed in claim 8, wherein the processor is adapted to identify matches between words in the input text and one or more pre-determined descriptive words; and is adapted to apply a weighting to a phoneme score where the phoneme score applies to a phoneme forming at least part of a pre-determined descriptive word.

11. An aural similarity measuring server as claimed in claim 8, wherein the processor is further adapted to select one or more reference texts from the plurality of reference texts for outputting via the output interface, the selection being based on the score assigned to each reference text, and the processor is further adapted to compare the selected one or more reference texts with reference texts selected by means of a different methodology for the purposes of identifying differences.

12. A trademark searching server comprising an aural similarity server in accordance with claim 8, wherein a plurality of reference trademarks are stored in the data store and the processor is adapted to generate a similarity score with respect to the aural similarity between an input trademark and at least one reference trademark from the data store.

13. A trademark searching server as claimed in claim 12, wherein the processor is adapted to identify descriptive words with respect to one or more of the following: i) the frequency with which the word occurs in ordinary language;
ii) the frequency with which the word occurs in registered trademarks in one or more or all classes of goods or services; and iii) the number of distinct proprietors owning registered trademarks which include the word.

14. A computer readable medium encoded with a computer program having instructions for aural similarity measurement, the computer program comprising program instructions for performing the following steps:
a receiving step in which an input text for which an aural similarity score is required is received;
a conversion step in which the input text is converted into a string of phonemes;
an adjustment step in which the phoneme string for the input text and/or a phoneme string associated with a reference text is adjusted so that the two phoneme strings are equal in length;
a ranking step in which the similarity of the two phoneme strings is assigned a score; and
an output step in which the reference text and the its ranking is output to the user.

15. A computer readable medium encoded with a computer program as claimed in claim 14, wherein the adjustment step and the ranking step are repeated for a plurality of reference texts.

16. A computer readable medium encoded with a computer program as claimed in claim 14, wherein the adjustment step comprises determining one or more adjustments of one or both of the input text phoneme string and the reference text phoneme string and the ranking step identifies the lowest score representative of the greatest similarity with respect to the possible adjusted phoneme strings.

17. A computer readable medium encoded with a computer program as claimed in claim 14, wherein matches are identified between the input text and one or more pre-determined descriptive words and a weighting is applied to a phoneme score where the phoneme score applies to a phoneme forming at least part of a word that has been identified as descriptive.

18. A computer readable medium encoded with a computer program as claimed in claim 15, wherein one or more reference texts are selected from the plurality of reference texts for outputting via the output interface, the selection being based on the score assigned to each reference text, and the selected one or more reference texts are compared with reference texts selected by means of a different methodology for the purposes of identifying differences.

19. A computer readable medium encoded with a computer program having instructions for trademark searching, the computer program comprising program instructions in accordance with claim 15 wherein the reference text comprises a plurality of reference trademarks and the processor is adapted to generate similarity scores with respect to the aural similarity between an input trademark and said plurality of reference trademarks.

20. A computer readable medium encoded with a computer program having instructions for trademark searching, the computer program comprising program instructions in accordance with claim 15, wherein the reference text comprises a plurality of reference trademarks and the processor is adapted to generate similarity scores with respect to the aural similarity between an input trademark and said plurality of reference trademarks and wherein descriptive words are identified with respect to one or more of the following: i) the frequency with which the word occurs in ordinary language; ii) the frequency with which the word occurs in registered trademarks in one or more or all classes of goods or services; and iii) the number of distinct proprietors owning registered trademarks which include the word.

21. An aural similarity measuring method for measuring the aural similarity of texts, the method comprising the steps of:
receiving an input text for which an aural similarity score is required;
converting the input text into a string of phonemes;
adjusting the phoneme string for the input text and/or a phoneme string associated with a reference text so that the two phoneme strings are equal in length;
ranking the similarity of the two phoneme strings to assign a score; and
outputting the reference text and its ranking to the user.
